(19) United States
(12) Patent Application Publication
(10) Pub. No.: US 2024/0035620 A1
(43) Pub. Date: Feb. 1, 2024

(54) CONCRETE ENHANCED ENERGY STORAGE APPARATUS

(71) Applicant: POWER8 TECH INC., Los Gatos, CA (US)

(72) Inventors: LIEN CHUN DING, Taoyuan (TW); CHIH CHENG TAI, Campbell, CA (US); TSENG-CHUNG TSAI, New Taipei City (TW)

(21) Appl. No.: 18/228,115

(22) Filed: Jul. 31, 2023

Related U.S. Application Data
(60) Provisional application No. 63/393,320, filed on Jul. 29, 2022.
(60) Provisional application No. 63/472,396, filed on Jun. 12, 2023.

(51) Int. Cl. F17C 1/00; F17C 1/12

(52) U.S. Cl. CPC F17C 1/007; F17C 1/12; F17C 2203/0333; F17C 2203/0678; F17C 2203/0624; F17C 2203/0639; F17C 2223/0153; F17C 2265/07; F17C 2201/0109

(57) ABSTRACT

An energy storage apparatus includes a energy storage for storing water and compressed gas; a concrete layer surrounded the energy storage; an inner protection layer arranged on an inner surface of the energy storage.

### CROSS-REFERENCE TO RELATED APPLICATIONS

This application claims priority to the U.S. Provisional Application No. 63/393,320, filed on Jul. 29, 2022, and entitled “A CONCRETE ENHANCED ENERGY STORAGE APPARATUS” and U.S. Provisional Application No. 63/472,396, filed on Jun. 12, 2023, and entitled “CONSTRUCTION OF ENERGY STORAGE VESSEL,” which are incorporated herein by reference for all purposes.

### FIELD OF THE DISCLOSURE

The present disclosure relates to an energy storage apparatus, and more particularly to the energy storage apparatus for storing energy using compressed gas and water and the construction and structure of the energy storage vessel.

### BACKGROUND OF THE DISCLOSURE

Generally, the common way to generate power, including, but not limited to from fossil fuels or renewable resources, is complicated and expensive. Typical energy storage systems for electricity include batteries, flywheels, and pumped hydro storages. Any systems are limited in the total amount of energy they can store. The most common typical examples of energy storage are advanced batteries, such as, lithium-ion batteries. However, the advanced batteries cause high production cost and also the energy application is limited. Flywheels energy storage could provide high energy power but have low energy power density. Pumped hydro storage is very limited on locations which requires specific geographical conditions.

### BRIEF SUMMARY OF THE DISCLOSURE

In a general implementation, an energy storage apparatus comprises a hollow energy storage unit for storing water and/or compressed gas; a concrete layer surrounding on the hollow energy storage unit; an inner protection layer arranged on an inner surface of the hollow energy storage unit. In some embodiments, a thermal path passed through the concrete layer and the inner protection layer, wherein the thermal path can be a heat conductive material (such as a metal wire or tube, e.g., a copper tube) for conducting heat in or out of the storage system.

In another aspect combinable with the general implementation, the hollow energy storage unit comprises an interior cavity communicated with the thermal path.

Further, it is contemplated that the hollow energy unit comprises a steel layer or a metal layer with different metal or alloys.

In some embodiments, the thickness of a wall of the hollow energy storage unit is thinner than a thickness of the concrete layer.

In one embodiment, the energy storage apparatus further comprises a water inlet to deliver the water into the hollow energy storage unit.

Another exemplary embodiment of the invention is an energy storage device. The energy storage device comprises a liquid source (e.g., water supply; a water reservoir); a gas tank; a mixing tank (e.g., having a mixture of liquid and air when the liquid is pumped into the mixing tank) communicated with the mixing tank and the gas tank; and an interior protection layer arranged on an inner surface of the mixing tank and the gas tank.

In some embodiments, the mixing tank or the gas tank comprises a concrete layer.

In some embodiments, the mixing tank or the gas tank further comprises a metallic wall encapsulated by the concrete layer.

In some embodiments, the mixing tank or the gas tank further comprising a heat conservative layer encapsulated by the concrete layer.

In some embodiments, the mixing tank or the gas tank further comprises a graphene layer.

In some embodiments, the interior protection layer comprises a concrete layer.

In some embodiments, the interior protection layer further comprises a fiber-reinforced plastic layer encapsulated by a concrete layer.

In some embodiments, the interior protection layer further comprises a graphene layer encapsulated by the fiber-reinforced plastic layer.

In some embodiments, the device further comprises a hydrogenerator connected to the mixing tank.

In some embodiments, the gas tank and the mixing tank are in the liquid source.

In some embodiments, at least one of the liquid source, the gas tank, and the mixing tank is located on ground level.

In some embodiments, at least one of the liquid source, the gas tank, and the mixing tank is located below ground level.

In some embodiments, at least one of the liquid source, the gas tank, and the mixing tank is partially located below ground level.

It is desirable to provide a practical and durable energy storage vessel.

In an implementation, a system for storing energy comprises an enhanced concrete energy storage apparatus having one or more energy storage vessel storing water and compressed gas; and a water pump for supplying water to the energy storage system.

In some embodiments, the system further comprises a water tank connected to the water pump for storing water.

In some embodiments, the system further comprises a gas generator/gas compressor connected to the energy storage apparatus for supplying compressed gas to the energy storage apparatus.

In an implementation, a system for storing energy, the system comprising: a concrete based energy storage having one or more energy storage storing water and compressed gas, wherein the concrete based energy storage contains a wall having an inner layer with a thermal layer, a structural reinforcement layer and an epoxy layer; and a water pump for supplying water from a water storage to the energy storage.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1A and FIG. 1B are top views of an energy storage apparatus according to some embodiments.

FIG. 2 is a perspective view of the energy storage apparatus according to some embodiments.

FIG. 3A, FIG. 3B, and FIG. 3C are perspective views of a hollow energy storage unit according to the embodiment.

FIG. 4 is a perspective view of the energy storage apparatus according to some embodiments.

FIG. 5 shows sectional views of the hollow energy storage unit according to some embodiments.

FIG. 6 illustrates an energy storage device in accordance with some embodiments.

FIG. 7 is a cross-sectional view of a mixing tank and an air tank according to some embodiments.

FIG. 8 illustrates an energy storage device 300 in accordance with some embodiments.

FIG. 9 is a schematic drawing of a system for storing energy apparatus according to an embodiment.

FIG. 10 is a schematic drawing of a use of the storing energy apparatus in a construction area according to an embodiment.

FIG. 11 to FIG. 15 illustrate one or more constructions of the storing energy apparatus in according to an embodiment.

FIG. 16 and FIG. 17 illustrates perspective views of the energy storing system in accordance with some embodiments.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

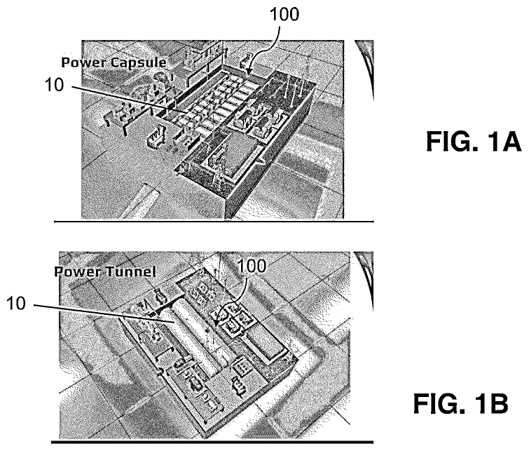

FIG. 1A and FIG. 1B generally depicts views of an energy storage apparatus 100 according to some embodiments.

In some embodiments, the energy storage apparatus 100 comprise one or more hollow energy storage units 10 for storing water and compressed gas, wherein the hollow energy storage unit 10 is in a form of a capsule sharp container. In another example, the hollow energy storage unit 10 is a tunnel shape container. In another example, the energy storage unit 10 comprises a civil construction structure, which can be similar to an oil tank.

In another embodiment, as shown in FIG. 1A, while the hollow energy unit 10 is a capsule sharp container, the dimension of each of the capsule is able to be approximately 2 meters (diameter)×10 meters (length). In still another embodiment, as shown in FIG. 1B, while the hollow energy unit 10 is a tunnel shape, the dimension of the tunnel can be approximately 10 meters (diameter)×100 meters (length). It should be understood that the above-described types of hollow energy storage unit 10 are exemplary and any other shapes/types of the hollow energy storage unit 10 can be adopted in various embodiments of this disclosure.

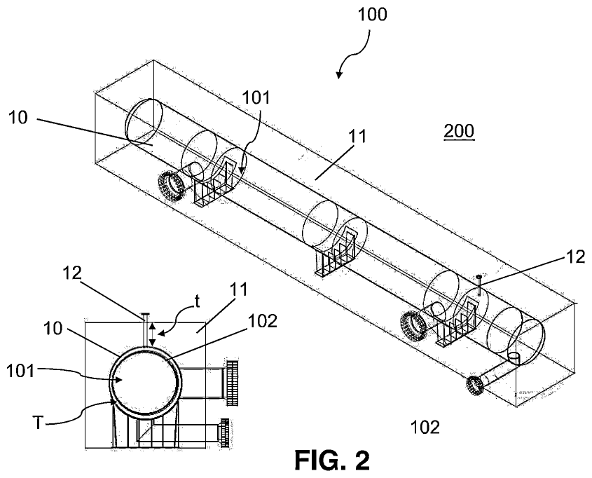

FIG. 2 depicts perspective views of the energy storage apparatus 100 according to some embodiments.

In some embodiments, the energy storage apparatus 100 may further comprise a concrete layer 11 surrounding on the hollow energy storage unit 10, wherein the hollow energy storage unit 10 may comprise an interior cavity 101 for storing water and/or compressed gas, and in such a manner, the concrete layer 11 may be surrounded outside the hollow energy storage unit 10. In some embodiments, the water is stored in one of the energy storage unit 10 fluidly couple with another energy storage unit 10 that is used to store gas (e.g., air, CO₂, or any other pure gases or mix gases). When more water (e.g., working fluid) is pumped into the unit 10 contains the water, such action reduced the spaces for storing gas so that the gas is compressed by the water. The air in the air tank can be pre-pressurized, such as 40 atm before water is pumped into the mixing tank. When the water is pumped into the mixing tank, water continuously taking more spaces, which reduces the spaces of air. As a result, the pressure of air continuously going up (e.g., from 40 atm to 60 atm).

In another some embodiments, the hollow energy storage unit 10 may further comprise an outer surface which is surrounded/encapsulated by the concrete layer 11 and an inner surface which defines the interior cavity 101, wherein the hollow energy storage unit 10 may further comprise a thickness “T” (e.g., a wall thickness) which defines between the outer surface of the hollow energy storage unit 10 and the inner surface of the hollow energy storage unit 10. It should be noted that, in some embodiments, the thickness “T” of the hollow energy storage unit 10 may be approximately 1 centimeter to 2 centimeters.

It should be understood that the above-described thickness of the hollow energy storage unit 10 are exemplary and any other thickness of the hollow energy storage unit 10 can be adopted in various embodiments of this disclosure.

In some embodiments, the concrete layer 11 may comprise a thickness “t” defined between an outer surface of the concrete layer 11 and the outer surface of the hollow energy storage unit 10, wherein the thickness “t” of the concrete layer 11 may be greater than the thickness of the hollow energy storage unit 10.

In still some embodiments, the energy storage apparatus 100 may further comprise an inner protection layer 102 arranged on the inner surface of the hollow energy storage unit 10, wherein the inner protection layer 102 may be a waterproof coating and/or an anti-rust coating and/or anti-corrosion coating, so as to protect the inner surface of the hollow energy storage unit 10 being damaging during long-time water/compressed gas storage.

In some embodiments, the inner protection layer 102 comprises a high thermal conductive material, which facilitate the heat distribution or directing heat conduction in a predetermined direction, rate, manner, pattern or timing. In some embodiments, the inner protection layer 102 comprises a heat conservative material, which keeps a predetermined amount of heat inside the storage unit 10.

In still some embodiments, the energy storage apparatus 100 may further comprise a thermal path 12 passed through the concrete layer 11 and the inner protection layer 102, wherein the thermal path 12 may communicate with the interior cavity 101 and an outside space 200 which is outside the concrete layer 11, and in such a way, heat and gas generated inside the interior cavity 101 may be guided to the outside space 200 through the thermal path 12, which can be stored for later use or other uses. For example, the heat and gas may be utilized to a second recycling. In some embodiments, the path 12 comprises a gas channel for gas to be vented out.

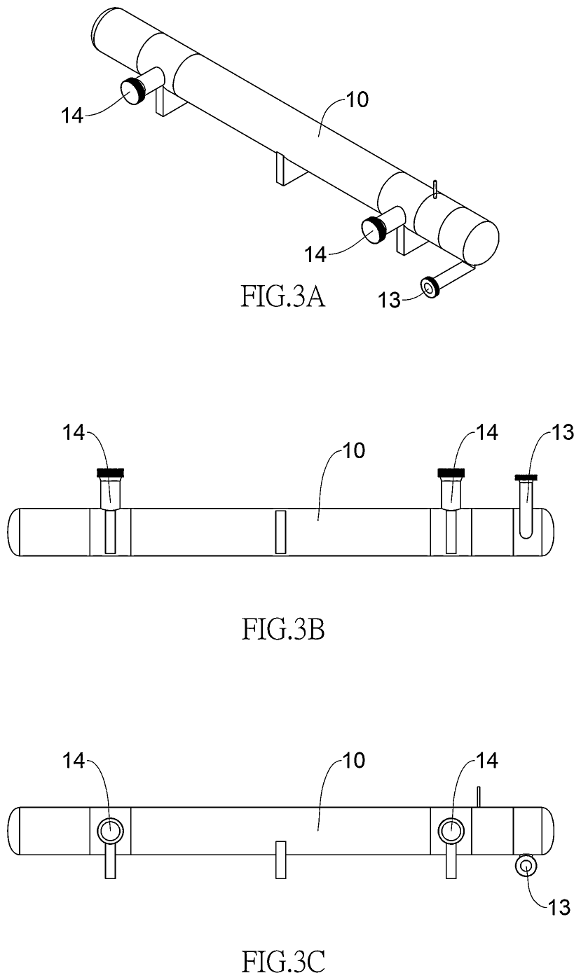

FIG. 3A, FIG. 3B, and FIG. 3C generally depict perspective views of the hollow energy storage unit 10 according to some embodiments.

In some embodiments, referring now to the detail of FIG. 3A to FIG. 3C, the hollow energy storage unit 10 may comprise a water inlet 13 to deliver the water into the interior cavity of the hollow energy storage unit 10. In another some embodiments, the hollow energy storage unit 10 may comprise a plurality of maintenance paths 14 communicated with the interior cavity and the outside space, and in such a situation, periodic maintenances may be implemented through the maintenance paths 14.

In still another some embodiments, the hollow energy storage unit 10 may comprise steel. For example, the wall of the hollow energy storage unit 10 may comprise carbon steel, stainless steel, alloy steel, tool steel, graphene and/or alloy steel. For another example, the alloy steel may include steel with manganese, vanadium, chromium, nickel, and/or tungsten.

It should be understood that the above-described materials of the hollow energy storage unit 10 are exemplary and any other materials can be adopted in various embodiments of this disclosure.

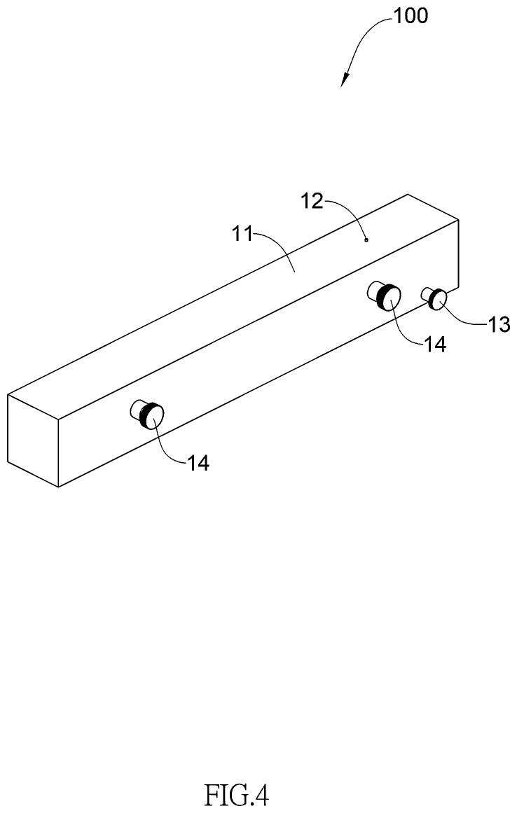

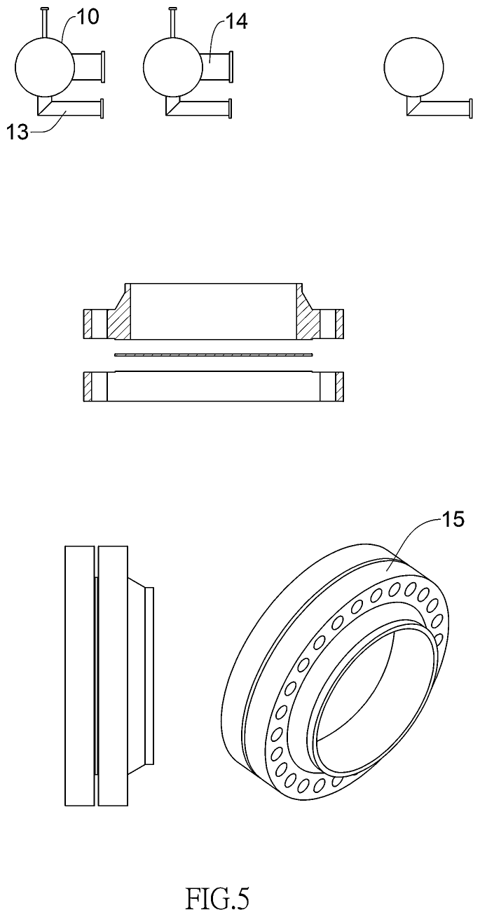

FIG. 4 perspective views of the energy storage apparatus 100 according to some embodiments.

Referring now to the detail of FIG. 4, the water inlet 13, maintenance paths 14, and the thermal path 12 may protrude out of the concrete layer 11. In one embodiment, the concrete layer 11 may be a rectangular layer or any other shapes (e.g., cylindrical shape) completely covering the outer surface of the hollow energy storage unit. In such a manner, in still one embodiment, the hollow energy storage apparatus 100 may sustain the pressure of many ranges of atmospheres, such as 100 atm to 200 atm. In still another embodiment, the hollow energy storage apparatus 100 may sustain the pressure of the atmosphere, such as 200 atm to 300 atm. In still another embodiment, the hollow energy storage apparatus 100 may sustain the pressure of the atmosphere, such as larger than 300 atm.

In some embodiments, the concrete layer 11 may comprise various types of concretes which may include reinforced concrete, lightweight concrete, high-strength concrete, high-performance concrete, and/or precast concrete. In still some embodiments, the concrete layer 11 may comprise ferrocement which using reinforced mortar or plaster (lime or cement, sand, and water) applied over an “armature” of metal mesh, woven, expanded metal, or metal-fiber. It should be noted that the concrete layer 11 may comprise an ultra-high-performance concrete which has a unique combination of superior technical characteristics including ductility, strength, and durability.

In some embodiments, the concrete layer 11 is used to reduce the need of the strength of the metal (e.g., steel). Thus, a thinner thickness of the metal wall of the (liquid and gas) container (e.g., unit 10) can be used. In other words, the concrete layer 11 is used to provide supporting force to the metal wall of the unit 10. In some embodiments, a formula is used to show the relationships among the concrete layer 11, the metal sheet of the unit 10's strength, and the required pressure endurance level, wherein the formula can be: P_{R1} (required safe pressure level)<P_{T1} (safe pressure level for a predetermined thickness of the metal sheet)+P_{CR} (safe pressure level for a predetermined thickness of the concrete layer).

In another embodiments, the formula can be P_{R1} (required (e.g., designed) safe pressure level)<P_{I1} (safe pressure level for a thickness to be constructed (e.g., actual construction) of the one or more layers of surrounding materials)+P_{CR} (safe pressure level for a predetermined thickness of the concrete layer (e.g., actual construction))

In some embodiments, the concrete layer 11 form a gas or liquid (e.g., water) container, which serves as the function of unit 10. In other words, the concrete layer 11 uses the concrete itself to form a gas/liquid container without using metal layer inside.

It is understood that the above-described types of concrete layers 11 are exemplary and any other types of concrete layers can be adopted in various embodiments of this disclosure.

In some embodiments, the concrete layer 11 uses Ultra-High Performance Concrete (UHPC). UHPC is a cementitious, concrete material that has a minimum specified compressive strength of 17,000 pounds per square inch (120 MPa) with specified durability, tensile ductility and toughness requirements; fibers are generally included in the mixture to achieve specified requirements. UHPC is a reactive powder concrete (RPC), which is able to be formulated by combining portland cement, supplementary cementitious materials, reactive powders, limestone and or quartz flour, fine sand, high-range water reducers, and water. The material can be formulated to provide compressive strengths in excess of 29,000 pounds per square inch (psi) (200 MPa). The use of fine materials for the matrix also provides a dense, smooth surface valued for its aesthetics and ability to closely transfer form details to the hardened surface. When combined with metal, synthetic or organic fibers it can achieve flexural strengths up to 7,000 psi (48 MPa) or greater.

Fiber types used in UHPC include high carbon steel, PVA, Glass, Carbon or a combination of these types or others. The ductile behavior of this material is a first for concrete, with the capacity to deform and support flexural and tensile loads, even after initial cracking. The high compressive and tensile properties of UHPC also facilitate a high bond strength allowing shorter length of rebar embedment in applications such as closure pours between precast elements.

UHPC construction is simplified by eliminating the need for reinforcing steel in some embodiments and the materials high flow characteristics that make it self-compacting. The UHPC matrix is very dense and has a minimal disconnected pore structure resulting in low permeability (Chloride ion diffusion less than 0.02×10-12 m²/s. The material's low permeability prevents the ingress of harmful materials such as chlorides which yields superior durability characteristics.

In some embodiments, some exemplary constructions have created just-add-water UHPC pre-mixed products that are making UHPC products more accessible.

In some embodiments, UHPC used is based on reactive powder materials (cement and mineral admixtures), fine aggregates, concrete admixtures (e.g., Concrete admixtures are natural or manufactured chemicals or additives added during concrete mixing to enhance specific properties of the fresh or hardened concrete, such as workability, durability, or early and final strength), high-strength fine steel fibers (and/or organic synthetic fiber compounds and water, the compressive strength is greater than 100 MPa. In some embodiments, the dense packing DSP theory is used to fill the voids of aggregate and cement particles with fully dispersed ultrafine particles to achieve particle packing densification. In some embodiments, Portland Cement (e.g., silicate with particle sizes 5-10 microns) are used which has been packed with silica fume particles (0.1-0.2 microns) in the gaps between the packed Portland Cement particles. Above, UHPC is able to be adjusted and modified with different materials to meet the requirements of predetermined functions.

The following is an example of the range of material characteristics for UHPC in accordance with some embodiments:

Strength

Compressive: 17,000 to 22,000 psi, (120 to 150 MPa)

Flexural: 2200 to 3600 psi, (15 to 25 MPa)

Modulus of Elasticity: 6500 to 7300 ksi, (45 to 50 GPa)

Durability

Freeze/thaw (after 300 cycles): 100%

Salt-scaling (loss of residue): <0.013 lb/ft3, (<60 g/m²)

Abrasion (relative volume loss index): 1.7

Oxygen permeability: <10-19 ft2, (<10-20 m²)

Using the formula disclosed above, a working example is illustrated.

P_{R1}(required safe pressure level)<P_{T1}(safe pressure level for a predetermined thickness of the metal sheet)+P_{CR}(safe pressure level for a predetermined thickness of the concrete layer) Equation (1)

P_{R1}(60 atm=operational pressure)<P_{T1}(safe pressure level for a predetermined thickness of the metal sheet)+P_{CR}(thickness of layer 11×UHPC strength) Equation (2)

P_{T1}(safe pressure level for a predetermined thickness of the metal sheet)>P_{R1}(60 atm=operational pressure)−P_{CR}(thickness of layer 11×UHPC strength) Equation (3)

In some embodiments, the enhanced strength concrete (e.g., layer 11 using UHPC) uses only predetermined thickness (e.g., 20-30 cm) to encapsulate the metal cylinder or container. Another layer of other cement (e.g., Poland Cement) is used to immobilize, filling the remaining spaces, and/or replacing a portion/all of using the enhanced strength concrete.

Similar to UHPC, other materials are able to be used for enhancing or providing support to the structure strength, including A-ECC, Engineered Cementitious Composite (ECC), High slump protection and super early strength shotcrete, microcement, lightweight aggregate concrete, rigid waterproof material

Engineered Cementitious Composite (ECC), Strain Hardening Cement-based Composites (SHCC), or a bendable concrete is an easily molded mortar-based composite reinforced with specially selected short random fibers, usually polymer fibers. Unlike regular concrete, ECC has a tensile strain capacity in the range of 3-7%, compared to 0.01% for ordinary Portland cement (OPC) paste, mortar or concrete. ECC therefore acts more like a ductile metal material rather than a brittle glass material (as does OPC concrete), leading to a wide variety of applications. Micro-cement (e.g., nano-cement) is composed of cement, water-based resin, modified polymer, quartz sand, etc. It has the characteristics of high strength, thin thickness, strong waterproof and seamless construction, etc.

Lightweight aggregate concrete is prepared with light coarse aggregate, light sand or ordinary sand, cementitious materials, admixtures and water with a dry apparent density not greater than 1950 kg/m³ of concrete.

Rigid waterproofing materials rely on the compactness of the structural components or using rigid materials as the waterproof layer to achieve the purpose of waterproofing the building. For example, high-efficiency anti-cracking and waterproofing agent is a kind of natural mineral as the main raw material, which is added through mineral activation, surface hydrophobic modification, functional compounding and other processes. In another example, an osmotic crystalline waterproof material is an active chemical substance (catalysis), which uses water as a carrier to enter the concrete capillary, and the catalytic reaction produces insoluble dendritic crystals, which can block concrete crack capillaries and achieve the purpose of permanent waterproofing and moisture-proofing of the structure.

It is a functional admixture that can improve the crack resistance and waterproof effect of cement-based materials.

FIG. 5 are sectional views of the hollow energy storage unit 10 according to an aspect of the embodiment.

As shown in FIG. 5, the hollow energy storage unit 10 may further comprise a sealing cap 15 hermetically covered on the maintenance paths 14.

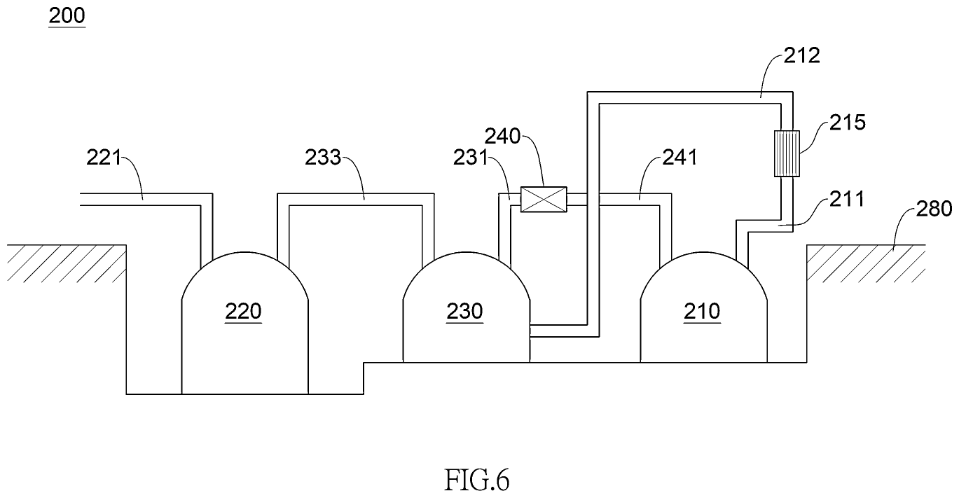

FIG. 6 illustrates an energy storage device 200 in accordance with some embodiments.

In the FIG. 6, the energy storage device 200 comprises a liquid container 210 (e.g., water reservoir) as a liquid source storing a liquid (e.g., water) for storing and supplying the liquid; a gas tank 220 storing a gas (e.g., air, He, or CO₂); a (e.g., air/water) mixing tank 230 communicated with the liquid container 210 and the gas tank 220. In these embodiments, the liquid container 210, the gas tank 220, and the mixing tank 230 are located below the ground level 280. In some embodiments, the liquid container 210, the gas tank 220, and the mixing tank 230 are located on the ground level. In some embodiments, at least one of the liquid container 210, the gas tank 220, and the mixing tank 230 is partially located below the ground level.

In operation, a power storage mode can use energy to pump the water from the liquid container 210 through the pipes 211 and 212 to the mixing tank 230 by using a pump 215, so that the gas in the mixing tank 230 and the gas tank 220 are further compressed, wherein the mixing tank 230 is communicated with the gas tank (e.g., air tank) 220 through the pipe 233. When the gas is compressed, the pressurized energy is stored. The pressure of the compressed/pressurized gas may be between 40-80 atm. In some embodiments, the gas tank 220 can be pre-pressurized (such as 20, 30, or 40 atm) through the pipe 221. In some other embodiments, the gas tank 220 can be pre-pressurized (such as 20, 30, or 40 atm) through repeating the process of pumping water into the mixing tank 230, sealing the gas tank 220, removing water from the mixing tank 230, connecting the gas tank 220 and the mixing tank 230, and pumping water into the mixing tank 230 until the pre-pressurized level reaches a predetermined level (such as 40 atm).

In an energy release/electricity generation mode, the compressed gas releases the pressurized energy to push the water out of the mixing tank 230 towards the pipe 231 to drive the generator 240 (e.g., water turbine) to generate the electricity. The water acting on the generator 240 can be guided through the pipe 241 to the liquid container 210 for recovery/recycle purposes.

In some embodiments, the hollow energy storage unit mentioned above may be used as the mixing tank 230 and/or the gas tank 220. Each of the gas tank 220, mixing tank 230, and/or the liquid container (e.g., water container) 210 can have a diameter (e.g., inner open space) of 20 meter and a height of 7-10 meter. In some embodiments, the gas tank 220 has a height of 10 meter and both the mixing tank 230 and liquid container 210 has a height of 7 meter. Thus, the respective spaces inside the gas tank 220, mixing tank 230, and the liquid container 210 is 4:3:3.

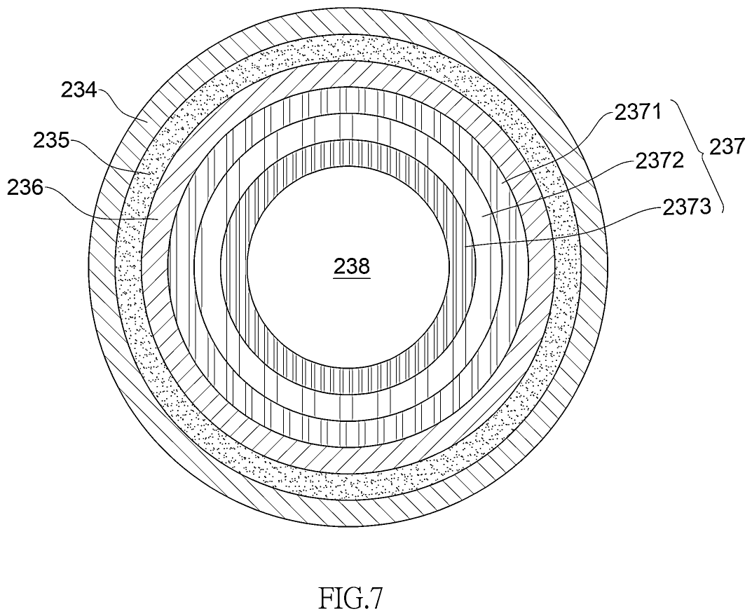

FIG. 7 is a cross-sectional view of a mixing tank according to an embodiment of the present disclosure.

As shown in FIG. 7, the mixing tank 230 or the gas tank 220 comprises a concrete layer 235, an interior protection layer 237, and a heat conservative layer 236 deposed between the concrete layer 235 and the interior protection layer 237, wherein the interior protection layer includes a concrete layer 2371, a graphene layer 2373, and a fiber-reinforced plastic layer (e.g., glass fiber reinforced plastic layer) 2372 deposed between the concrete layer 2371 and the graphene layer 2373. In this embodiment, the mixing tank 230 further comprises a graphene layer 234 encapsulating the concrete layer 235. These layers defines an interior chamber 238. In this embodiment, the graphene layer 2373 can be used to absorb the heat generated during the energy storage. The absorbed heat can be released during the energy generation. Besides, graphene mainly provides the ability to withstand pressure, so the thickness and relative strength of graphene used in the structure can be adjusted according to the pressure provided by the graphene and the cement. Specifically, the thickness and relative strength of graphene can be adjusted in accordance with the following equation.

Thickness vs. type and number of cement and steel bars>the pressure value of the required pressure Equation (4)

Therefore, any ratio and proportioning is within the scope of this invention. Moreover, the thickness of the concrete layer 235 and/or the concrete layer 2371 can be reduced by the graphene layers 234 and 2373.

In some embodiments, the interior protection layer is a single layer structure.

In some embodiments, the heat conservative layer 236 is made of polyurethane.

In some embodiments, the heat conservative layer 236 is replaced with a metallic wall.

In some embodiments, the mixing tank further comprises a metallic layer encapsulating the concrete layer 235.

In some embodiments, the gas tank 220 has the same layer structure as the mixing tank 230.

In some embodiments, the concrete layer may comprise various types of concretes which may include reinforced concrete, lightweight concrete, high-strength concrete, high-performance concrete, and/or precast concrete. In still some embodiments, the concrete layer 11 may comprise ferrocement which using reinforced mortar or plaster (lime or cement, sand, and water) applied over an “armature” of metal mesh, woven, expanded metal, or metal-fiber. It should be noted that the concrete layer may comprise an ultra-high-performance concrete which has a unique combination of superior technical characteristics including ductility, strength, and durability.

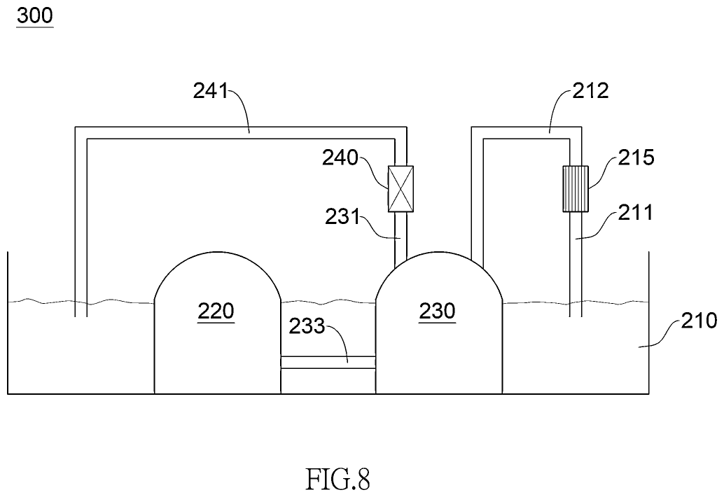

FIG. 8 illustrates an energy storage device 300 in accordance with some embodiments.

In FIG. 8, the energy storage device 300 comprises a liquid tank 210 as a liquid source storing a liquid (e.g., water) and supplying the liquid; a gas tank 220 storing a gas (e.g., air, He, or CO₂); a mixing tank 230 communicated with the liquid tank 210 and the gas tank 220. In these embodiments, the gas tank 220 and the mixing tank 230 are located in the liquid tank 210. In some embodiments, the liquid tank 210 may be a natural facility, e.g., a lake or pool. The liquid tank 210 also serves as a protection facility preventing leaking from the gas tank 220 and the mixing tank 230.

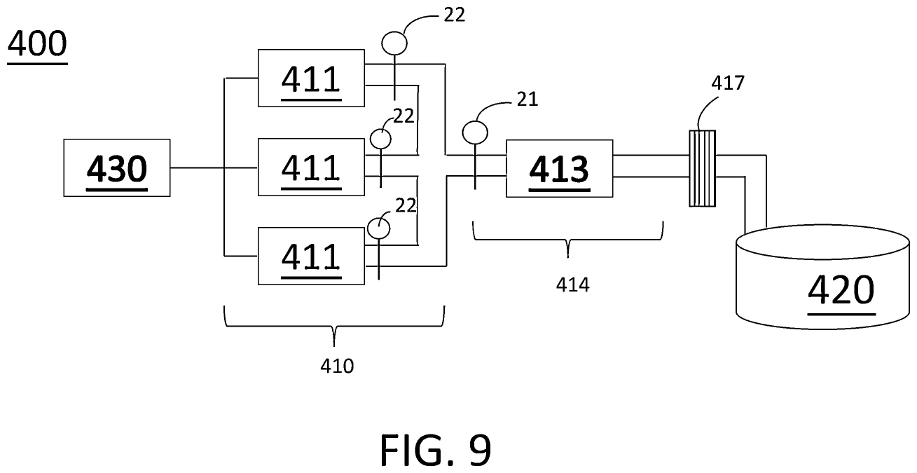

FIG. 9 is a schematic drawing of a system 400 for storing energy apparatus according to an embodiment. In one embodiment, the system 400 obtains water from a water source 20, which can be configured to be obtained ON-Demand, in real-time, or as needed basis so that the system does not need to pre-store all needed water. The water source 420 includes oceans, rivers, streams, lakes, reservoirs, springs, groundwater (e.g., an aquifer), and reused water. The above-described water sources are exemplary, and any water sources can be adopted in various embodiments of this disclosure. In some embodiments, the water can be pre-stored in a water tank to be re-used as circulation water.

In one embodiment, the energy storage apparatus 410 comprise one or more energy storage units 411 for storing water and compressed gas, a concrete layer encapsulating the energy storage units 411, an inner protection layer on an inner surface of the energy storage unit 11, and a thermal path passed through the concrete layer and the inner protection layer. In some embodiments, the energy storage apparatus 410 is concrete enhanced, which is entirely encapsulated by concrete. In some embodiments, the energy storage apparatus 410 contains standalone metal tanks without concrete encapsulated. In some other embodiments, the energy storage apparatus 410 contain metal tanks with one or more partial portions that is encapsulated by concrete, polymer or any other protective materials. In some embodiments, the energy storage unit 411 is mainly formed by a concrete structure, which is further disclosed in detail below. The energy storage unit 11 can be constructed like a crude oil storage having a substantially cylindrical or ball shape, which can have a dimeter from 10 m to 30 m.

In one embodiment, the system 400 may further comprise a water tank 413 controlled/communicated with the water distribution system 414 for storing water, which is delivered from the water source 420. In some embodiments, the water tank 413 is optional and is omitted, so that the water distribution system 414 can directly distribute water to the energy storage apparatus 410 without being stored first.

In one embodiment, the water pump 417 may be used to deliver water from the water source 420 to the energy storage apparatus 410, wherein the water pump 417 may be equipped with a meter to identify the amount of water dispensed to one or more energy storage units 411. In still another embodiment, the system 400 may further comprise a processing unit 413 communicated to the water pump 417 and the energy storage unit 411, wherein the processing unit 413 may comprise a filter to remove dissolved solids. For one example, the filter may be a desalination unit for removing most of the dissolved solids and converting salt water from the water source to purified water. One or more valves 21, 22 are installed throughout the system 400, which can be controlled manually, electronically, and/or remotely (e.g., controlled via a GUI (Graphical User Interface) user interface. A GUI uses windows, icons, and menus to carry out commands, such as opening, deleting, and moving files.)

In this embodiment, the system comprises a hydrogenerator 430 for generating electricity. The hydrogenerator 430 may be connected to one or more energy storage units 411.

Constructions and operating methods of the energy storage system are further disclosed in the associated patent applications U.S. patent application Ser. No. 17/777,516, PCT/US2022/029374, and CN202111466565.5, which are incorporated by references in their entirety for all purposes.

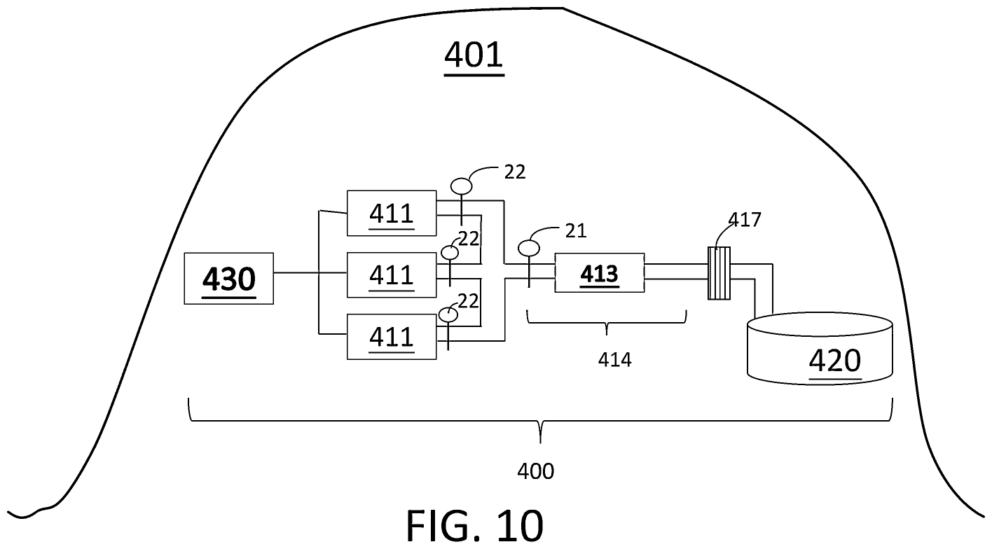

FIG. 10 is a schematic drawing of a use of the storing energy system 400 in a mountain area 401 according to an embodiment. The storing energy system 400 can be installed in a mountain, a house, a factory, underground, or any other land-based areas.

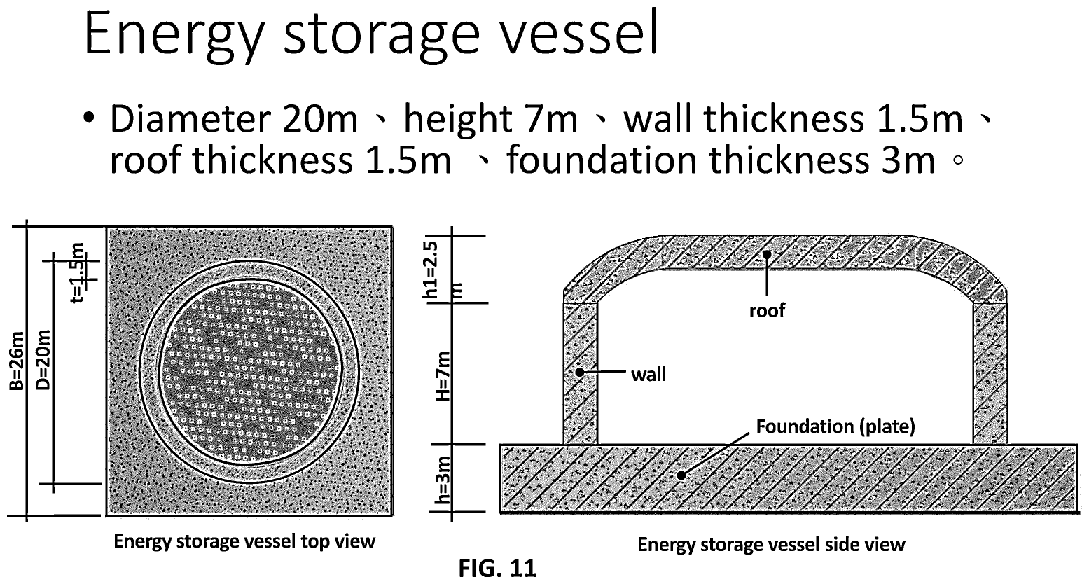

FIG. 11 to 15 illustrate one or more constructions of the storing energy apparatus in according to an embodiment.

FIG. 11 illustrates a construction of an energy storage vessel (like energy storage unit 411 of FIG. 9). In this embodiment, the vessel is designed to have a gas pressure of 60 atm. The vessel contains a foundation, side walls, and a roof. The foundation provides a stability support for the structure above preventing soil conditions to affect the structure. Fluidic pipes and controlling valves are further implemented similar to the constructions disclosed in the associated patent applications.

In one of the operational modes, a first structure (e.g., the energy storage vessel) is pre-pressurized to a predetermined pressure, such as 40 atm. When water is pumped into a second structure (e.g., the energy storage vessel), and the air is squeezed into the first structure via a fluid channel. Due to space replacement, the air in the second structure is pushed or compressed into the first structure, which causes the pressure in the first structure goes up (e.g., 60 atm) due to the reduction of the gas spaces. The first structure, the second structure, or both are designed to endure a gas pressure up to 100 atm. The above is a mode of energy storage. When releasing the energy, the gas pressure pushes the water in the first, second, or both of the structures to drive a hydrogenerator so that electricity is generated.

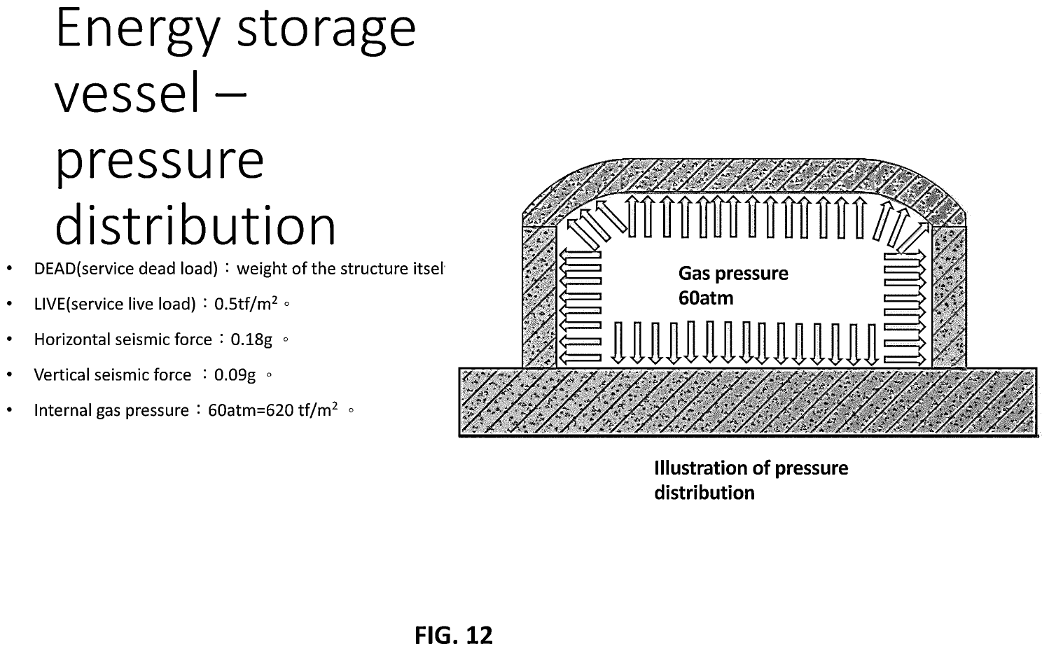

FIG. 12 illustrates a pressure distribution of the gas pressure.

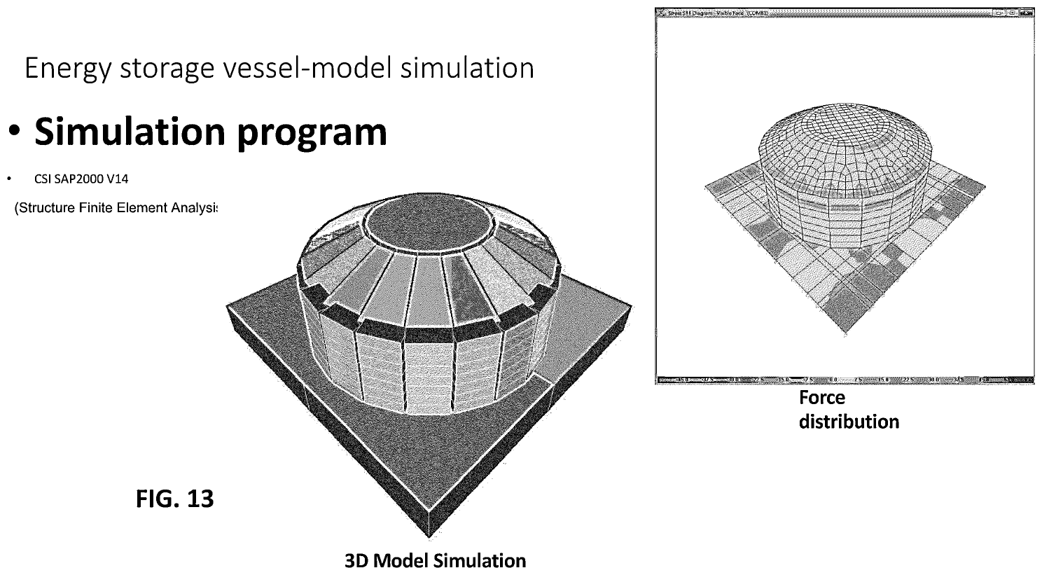

FIG. 13 illustrates a computer simulated structural stress simulation result showing the structure is fit to be used as a gas pressure holding structure.

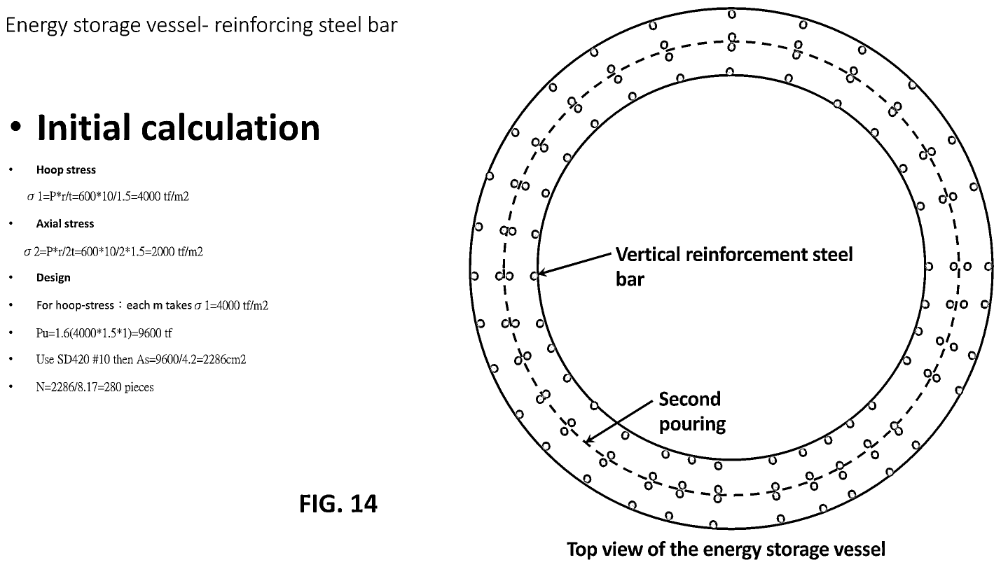

FIG. 14 illustrates a top view of the energy storage vessel having vertical reinforcement bar around the walls.

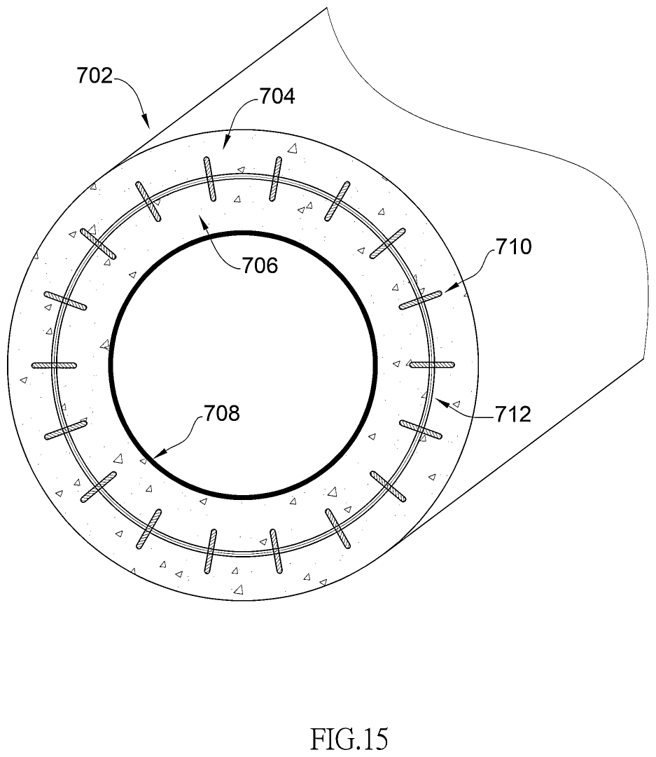

FIG. 15 illustrates a construction of the walls 702 of the energy storage vessel. The wall has an outer layer RC structure 704, an inner RC structure 706, rebars 710, thermal insulator 712 (e.g., PU (poly-urethane) layer), and an inner layer 708. The inner layer 708 can contain polyurea (e.g., sioUrea 5000 or 6000), epoxy resin, graphene, and/or RFP (glass fiber reinforced plastic), which are used for structural strength reinforcement and also serves as waterproof materials. In some embodiments, the outer layer RC 704 is encapsulated by a graphene. As mentioned above, graphene mainly provides the ability to withstand pressure, so the thickness and relative strength of graphene used in the structure can be adjusted according to the pressure provided by the graphene and the cement (e.g., reinforced cement). Specifically, the thickness and relative strength of graphene can be adjusted in accordance with the equation (4). Therefore, any ratio and proportioning is within the scope of this invention.

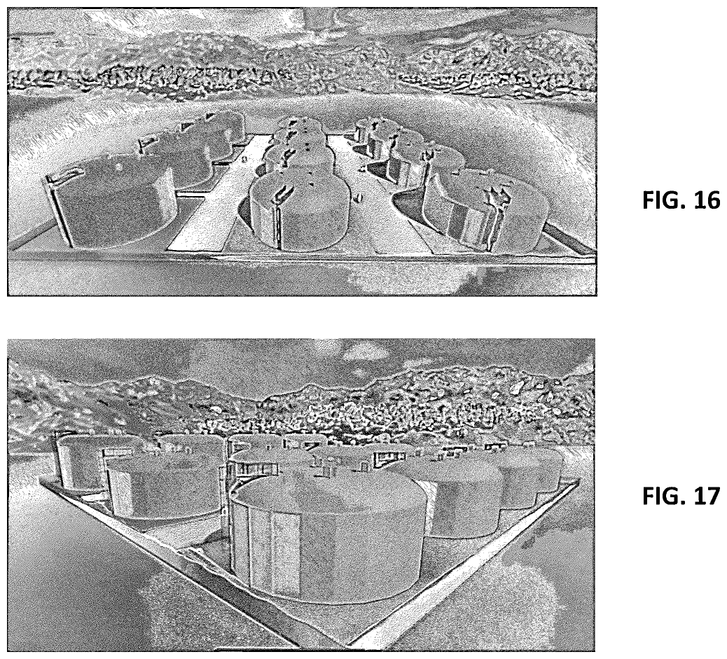

FIG. 16 and FIG. 17 illustrates a perspective view of the energy storing system in accordance with some embodiments. Each of the vessel contains three to four vents on top of the vessel, which can be used for safety valves and entrance for maintenance.

In utilization, the system 400 can be used as an energy storage, air/gas storage, fuel/fluid (e.g., water) storage facilities. The air, gas, water, and/or fuel stored can be used as needed.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of energy storage apparatus have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. An energy storage apparatus, comprising:
a) a first structure configured to contain a default pressure of a pressurized gas; and
b) a second structure configured to receive a first amount of a liquid from a liquid source so that a pressure level in the first structure increases from the default pressure to an increased level associated with a space replacement in the second structure.

2. The energy storage apparatus of claim 1, wherein the first structure is a concrete based structure.

3. The energy storage apparatus of claim 1, wherein the first structure has a graphene layer.

4. The energy storage apparatus of claim 1, wherein the first structure has a fiberglass layer.

5. The energy storage apparatus of claim 1, wherein the first structure has a thermal isolation layer.

6. The energy storage apparatus of claim 1, wherein the thermal isolation layer comprise polyurethane.

7. The energy storage apparatus of claim 1, wherein the first structure has a concrete layer.

8. The energy storage apparatus of claim 6, wherein the concrete layer comprises steel reinforce bars.

9. The energy storage apparatus of claim 1, wherein the second structure has a concrete layer, a graphene layer, a fiberglass layer, and steel reinforce bars.

10. An energy storage device, comprising:
a liquid source;
a gas tank;
a mixing tank communicated with the liquid source and the gas tank; and
an interior protection layer arranged on an inner surface of the mixing tank and the gas tank.

11. The energy storage device of claim 10, wherein the mixing tank or the gas tank comprises a concrete layer.

12. The energy storage device of claim 11, wherein the mixing tank or the gas tank further comprises a metallic wall encapsulated by the concrete layer.

13. The energy storage device of claim 11, wherein the mixing tank or the gas tank further comprising a heat conservative layer encapsulated by the concrete layer.

14. The energy storage device of claim 10, wherein the mixing tank or the gas tank further comprises a graphene layer.

15. The energy storage device of claim 8, wherein the interior protection layer comprises a concrete layer.

16. The energy storage device of claim 10, wherein the interior protection layer further comprises a fiber-reinforced plastic layer encapsulated by a concrete layer.

17. The energy storage device of claim 16, wherein the interior protection layer further comprises a graphene layer encapsulated by the fiber-reinforced plastic layer.

18. The energy storage device of claim 10, further comprising a hydrogenerator connected to the mixing tank.

19. The energy storage device of claim 10, wherein the gas tank and the mixing tank are in the liquid source.

20. The energy storage device of claim 10, wherein at least one of the liquid source, the gas tank, and the mixing tank is located on ground level.

21. The energy storage device of claim 10, wherein at least one of the liquid source, the gas tank, and the mixing tank is located below ground level.

22. The energy storage device of claim 10, wherein at least one of the liquid source, the gas tank, and the mixing tank is partially located below ground level.
